(19) United States
(12) Patent Application Publication
(10) Pub. No.: US 2008/0157930 A1
(43) Pub. Date: Jul. 3, 2008

(54) Object name service for RFID tags

(76) Inventors: Steve Winkler, San Francisco, CA (US); David Burdett, Orinda, CA (US)

Correspondence Address: SAP / FINNEGAN, HENDERSON LLP, 901 NEW YORK AVENUE, NW, WASHINGTON, DC, 20001-4413, US

(21) Appl. No.: 11/647,194

(22) Filed: Dec. 29, 2006

(51) Int. Cl. H04Q 5/22

(52) U.S. Cl. 340/10.3

(57) ABSTRACT

An Object Name Service (ONS) is provided through an electronic product code information service (EPCIS) interface that allows one or more accessing applications residing on a variety of systems and associated with a plurality of enterprises/organizations to locate a network accessible service that provides EPC-related data associated with an EPC. A root server of the ONS may identify the network accessible service using a look-up system based on Domain Name System.

### TECHNICAL FIELD

The field of the invention relates in general to radio frequency identification (RFID). More particularly, the field of the invention relates to an Object Name Service for locating network accessible services pertaining to a uniquely identified RFID tag or another suitable identification mechanism.

### BACKGROUND

Radio frequency identification (RFID) technology is being used at an expanding rate by manufacturers, retailer, logistics providers, and other users to replace or supplement a variety of traditional systems. Most notably, RFID technology may be implemented as a part of a supply chain management system to facilitate tracking, securing, and managing of items from manufacturing to retail.

In essence, RFID works by enabling a wireless exchange of information between a tagged object and a reader/writer, which in turn allows a host to process the information associated with the tagged object. FIG. 1 shows one example of such an RFID system. Three components are included in this basic RFID system 100. First, one or more tags 102 or transponders may be deposited on an item to be tracked. The item may be any suitable item known to those skilled in the art upon which an RFID tag may be attached, such as retail merchandise. The tags 102 may vary in shapes, sizes, and materials to suit the conditions of the item. Each RFID tag 102 may include two components, a computer chip 106 and an antenna 108. Appropriate information associated with the tagged item, including, for example, item name, description, or any other suitable item-related information, may be stored on the computer chip 106 and/or a server away from the tag.

Depending on the application, the tags 102 may be passive, active, or battery assisted. Passive tags generally utilize the power derived from the signals sent by a reader to respond to the reader. Active tags power their transmissions with an attached battery, while battery-assisted tags use an attached battery to power chip electronics, but does not use the battery for transmission. While the less costly passive tags are most frequently used in connection with supply chain management systems, active tags play a major role in marking shipping containers etc. in the supply chain management systems.

Functionally, tags 102 may fall into two categories, read-only or read/write. Read-only tags are programmed with a fixed set of information during manufacturing, and this information cannot be altered at a later time. Read/write tags on the other hand allow writing and/or rewriting of its information by an authorized user. Some read/write tags may include a read-only portion in which certain information may be stored and protected while allowing other information stored in a writable portion to be modified. Some examples for modifying the read/write tags, for example, to effect tracking of a product from manufacturing to retail, will be discussed in more detail below.

One or more read/write devices or interrogators 110 may be used to communicate with the tags 102. The read/write device 110 may include an antenna 112, a transceiver 114, and any other suitable components for facilitating reading and writing to tags 102. Typically, to communicate with a particular tag or set of tags 102, the read/write device 110 sends out through transceiver 114 and antenna 112 an RF signal in the frequency to which the target tags 102 are tuned. In response to receiving the signal, the targeted tags 102 respond by transmitting at least a part of their stored data. Upon receiving the data transmitted by the tags 102, the reader/writer 110 decodes the data and may transfer the data to a host computer system 116 for processing. The reader/writer 110 may either be fix-positioned or portable and may be either wired or wireless.

An RFID tag often contains data in the form of an Electronic Product Code (EPC). The EPC is essentially a unique serial code that is assigned to the item to which the RFID tag is affixed or otherwise associated. The tag may also contain EPC-related information, i.e., any suitable information that has been associated with the item bearing an EPC.

An RFID system provides many advantages over traditional tracking and inventory systems that utilize code-based technologies (e.g., bar code). Most notably, RFID utilizes radio frequency for communication and therefore may communicate with multiple tags positioned out of sight. In addition, much more information may be stored on an RFID tag, which provides a broad range of opportunities for associating various information with the tracked items. The read/write tags have the added advantage of reusability and modifiability, which reduces replacement cost and allows more accurate and flexible association of information with the tracked items.

In view of the above advantages associated with RFID technology, many enterprises/organizations have developed applications for implementing RFID in their various operations. An enterprise/organization in the context of this application may be any entity that is capable of implementing RFID technology in connection with its operations and/or products. For example, RFID tags may be attached to individual products as they come off the production line at a manufacturer's factory. These tags may contain data such as the date of production, special product care instructions (i.e., a special temperature that the product is to be kept at), and/or any other suitable information that the manufacturer wishes to have associated with the product. The manufacturer may store the tag information in its own database. Scanning of the tags as the products leave the factory, for example, via a tag reader fixed to a door, may inform the manufacturer which products are no longer stored in the factory. This information may be used to update the manufacturer's database, which may in turn allow the manufacturer to monitor, manage, and/or optimize its business, for example, by using the data to assess whether it has been consistently shipping out the oldest products in accordance with its first-in-first-out (FIFO) policy.

This example illustrates one scenario in which RFID data collection, storage, and analysis may be helpful to a manufacturer, for example, for streamlining its operations. Many other scenarios exist where RFID data may be used to optimize, manage, and otherwise benefit an enterprise/organization. Additionally, because today's businesses are interconnected with each other in a plethora of ways, it is quite probably that one enterprise/organization's RFID data may also be very beneficial to other enterprises/organizations such as enterprises/organizations situated down the supply chain from the manufacturer.

In one particular scenario, an enterprise/organization, acting in the role of a retailer that purchases from the above manufacturer, may wish to gain access to the manufacturer's stored RFID data, including production date and shipped date data. Using this data, the retailer may determine the best time to schedule its quarterly shipment from the manufacturer to ensure that the manufacturer will have enough products on hand to satisfy the retailer's needs.

In another scenario, the enterprise/organization, in its retailer role, may wish to gain access to the manufacturer's stored RFID data, for example, with regard to the special condition that the products have been kept under (i.e., temperature for perishable food). Using this data, the retailer may determine whether an expiration date can be properly applied because the products have been kept according to the manufacturer's special instructions.

On the reverse side, the enterprise/organization in the manufacturer role may wish to analyze the retailer's RFID data, for example, generated from sales made at the cash register, to infer how many products have been sold within a particular period. The manufacturer may use this data to adjust its production schedule to promptly satisfy reorder demands from the retailer.

These examples demonstrate, at a high level, some benefits of RFID data access both within and across enterprises/organizations in their various related roles. Many other scenarios exist in which data sharing among a plurality of users acting in a variety of roles within an enterprise/organization and across multiple enterprises/organizations could be advantageous for everyone involved.

Many enterprises/organizations have realized the power of such data sharing, but few have made it a reality due to the obstacles associated with such sharing. A primary obstacle is an enterprise/organization's concern over proper authorization of an enterprise/organization and/or a particular user within an enterprise/organization that accesses the data. For example, the enterprise/organization acting in a retailer role in the above examples may wish the enterprise/organization acting in a related manufacturer role to see how many of the manufacturer's products are left in the retailer's warehouse to enable the manufacturer to restock automatically. At the same time, the retailer may not wish the manufacturer to gain access to information about what other products are being stored in the retailer's warehouse or sold at its registers. Additionally, the retailer may be concerned with which individuals and/or sub-organizations within the manufacturer's organization are accessing the retailer's data. For example, the retailer may only wish to share its data with a user acting in a product management role (e.g., manufacturer's production manager) to see the relevant product information and would like to prevent individuals outside of that role (e.g., warehouse workers) from accessing the same information.

One way to address the above need of the retailer may be to require that the retailer modify its database to prevent the enterprise/organization acting in the manufacturer role from seeing some subsets of data. The retailer could further restrict the data view scope of specific individuals and/or sub-organizations acting in specific roles within the manufacturer's organization. This approach may work if the sharing is only on a small scale between a limited number of enterprises/organizations, each having a small number of sub-organizations and/or individuals with data access capabilities. The approach is less desirable, however, if the number of organizations, individuals, and/or sub-organizations sharing the data are large or the databases themselves are vast because each sharer must be painstakingly assessed, prevented, or allowed to view specific data sets.

Another obstacle for sharing RFID data across enterprises/organizations is that data warehousing and data mining are performed very differently from one enterprise/organization to another. It is not uncommon for two enterprises/organizations to differ in everything from the type of databases to the type of hardware to the type of network connections they use. Since different hardware and software rarely work together in a cohesive and smooth manner without considerable integration work, RFID data sharing can be difficult from a technical standpoint.

Furthermore, when RFID data are warehoused on distributed systems located throughout the network, identifying the appropriate system from which to obtain desired data and/or service becomes yet another obstacle. Currently, some systems solve this problem through reliance on pre-established relationships and/or hard-coded internal directories that specify, for example, location information associated with desired data. This solution is often inaccurate because there are no consistent rules for updating the relationships and/or directories when changes occur. The approach also creates major burdens on the accessing system that desires remote data because it must internally maintain the various directories and/or relationships that require frequent updating and have the potential to reach unmanageable size.

In view of the above, a need exists for an improved way of providing a sensor-related data (e.g., EPC/RFID data) sharing scheme so that enterprises/organizations and their associated individuals and sub-organizations participating in the data sharing scheme may gain access to sensor-related data collected and stored by other enterprises/organizations in a seamless fashion. An additional need exists for the data sharing scheme to provide a scalable way to allow an accessing application in one enterprise/organization to locate desirable data and/or service that reside on remotely distributed servers of other enterprises/organizations.

### SUMMARY

Consistent with the principles of the present invention, an Object Name Service (ONS) is provided through a standard data sharing service such as an electronic product code information service (EPCIS) or any other suitable service interface that allows one or more accessing applications residing on a variety of systems and associated with a plurality of enterprises/organizations to locate desirable sensor-related data, such as and hereinafter collectively referred to as EPC-related data, provided by a network accessible service. It will be understood that while EPCIS is given as the specific example of a data sharing service, any other suitable data sharing service may be used without departing from the spirit of the present invention.

The network accessible service may be owned and provided by any of a plurality of enterprises/organizations and may be hosted on any of a variety of systems. The EPCIS interface may act as a bridge to connect the diverse systems both inside and outside of an enterprise/organization and may enable data exchange between the systems in a seamless fashion using standard rules that each system understands.

The Object Name Service may be provided by a plurality of distributed ONS root servers that are managed by different entities (e.g., various enterprises/organizations who own the EPCs). In some embodiments, the ONS may be implemented based on the Domain Name System. As an example, when an EPCIS accessing application provides an EPC to one of the ONS root servers, for example, in the form of a domain name, the receiving ONS root server may use at least a portion of the provided EPC to identify a network accessible service that provides data associated with the EPC. In some embodiments, the ONS root server may use a header number associated with the EPC to identify, for example, from an object server directory, an appropriate object server from which to obtain information about the network accessible service. In some embodiments, the ONS root server may use a manager number associated with the EPC to uniquely identify an object server that has information about network accessible services associated with EPCs belonging to that manager (e.g., an enterprise).

Once the appropriate network accessible service is identified, the ONS root server may provide a pointer to the service to the EPCIS accessing application so that the EPCIS accessing application may receive data associated with the EPC from the network accessible service.

In some embodiments, the ONS root server that received the EPC may query another ONS root server to identify the network accessible service. In such a case, the requesting ONS root server may locally cache the pointer provided by the other ONS root server to the identified network accessible service. In this way, the ONS root server may avoid querying the other ONS root server for the same information when the same network accessible service is requested.

In some embodiments, each of a plurality of ONS root servers may replicate data associated with the other ONS root servers so every ONS root server may be capable of providing accurate pointers to network accessible services without having to query other ONS root servers.

Further features and embodiments of the present invention will become apparent from the description and the accompanying drawings. It will be understood that the features mentioned above and those described hereinafter may be used not only in the combination specified but also in other combinations or on their own, without departing from the scope of the present invention. It will also be understood that the foregoing background, summary, and the following description of the systems consistent with the principles of the present invention are in no way limiting on the scope of the present invention and are merely illustrations of a preferred embodiment of the present invention.

### BRIEF DESCRIPTION OF THE DRAWINGS

Referring now to the drawings, in which like numerals represent like elements throughout the several Figures, aspects of the present invention and the exemplary operating environment will be described.

FIG. 1 is a block diagram of an illustrative RFID system for facilitating reading and writing to a read/write RFID tag.

FIG. 2 is a schematic block diagram illustrating the relationships within an EPCglobal Architecture Framework.

FIG. 2A is a schematic block diagram illustrating an Object Name Service infrastructure implemented based on the DNS hierarchy.

FIG. 2B is an illustrative EPC encoded on a 96-bit RFID tag.

FIG. 2C is an illustrative EPC encoded into a domain name.

FIG. 2D is an illustrative directory for identifying object servers based on header information associated with EPCs.

FIG. 2E is a block diagram illustrating local caching by an ONS server of pointers to network accessible services.

FIG. 3 shows a block diagram of suitable layers that may be implemented in connection with an EPCIS framework.

FIG. 4 shows an illustrative set of master data and event data consistent with the EPCIS framework.

FIG. 5 is a block diagram of one suitable arrangement for allowing EPCIS interfaces to interact with each other and with EPCIS accessing applications.

FIG. 6 shows a computer system capable of implementing elements of the EPCIS framework.

FIG. 7 shows another computer system capable of implementing elements of the EPCIS framework.

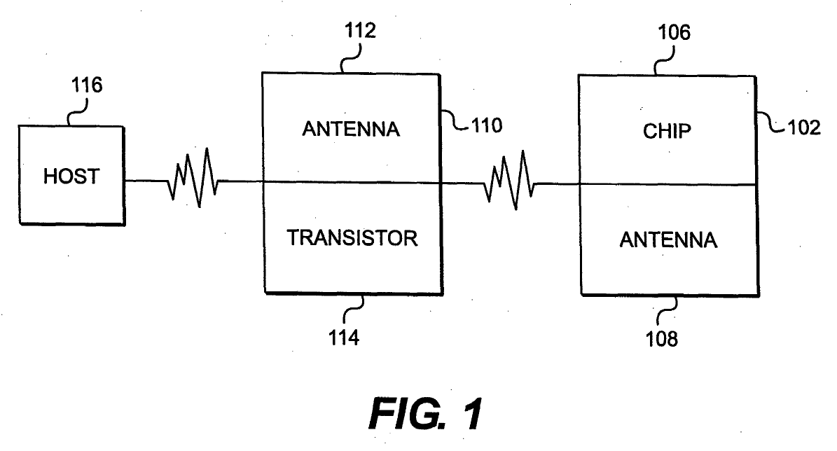

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Consistent with the principles of the present invention, a method and system is provided in connection with an Electronic Product Code Information Service (EPCIS) or another suitable service to enable participating enterprises/organizations and its associated sub-organizations and/or individuals to share Electronic Product Code-related data (e.g., obtained from RFID tags) through a role-based access scheme. It will be understood that while EPCIS is provided as specific example, any other suitable service based on any other suitable standard may be implemented without departing from the spirit of the present invention.

At a high level, the Electronic Product Code Information Service (EPCIS) specifies a standard interface for accessing EPC-related information. EPC-related information may be any suitable information that has been associated with an object bearing an Electronic Product Code (EPC), which usually involves a unique serial number that is assigned to the object via an RFID tag.

Typically, EPC-related data falls into two broad categories. One category involves timestamped event data that is collected throughout the lifecycle of an object. This type of event data may include, for example, observation data associated with tag readings (e.g., time data associated with scanning of the RFID tag of a product at a retail register), measurement data (such as sensor readings, temperature history, etc.), location history, business transaction history, and any other timestamped event data. Another category of EPC-related data involves attribute data that is, for example, a fixed part of the RFID tag and is not continuously updated. This type of data may include, for example, manufacturing date, expiration date, and any other data that is specific to the product with which the EPC is associated and does not require continuous updating.

Unlike other networks that are concerned with synchronization of data about products (i.e., the GDSN, UCCNet, etc.), EPCIS is primarily focused on sharing of serial-level EPC-related data via a much more distributed architecture. What EPCIS provides is a technical specification for a data communication interface in a model that allows different applications to leverage EPC-related data both within and across enterprises/organizations. In particular, the EPCIS enables the capturing and querying of EPC-related data using a defined set of service operations and associated EPC-related data standards, all combined with appropriate security mechanisms that satisfy the needs of user enterprises/organizations. In other words, the EPCIS places no restrictions on the different enterprises/organizations' underlying database, underlying operating system, underlying programming language, or underlying information system integration.

With regard to the standard interface for accessing the EPC-related data, EPCIS supports both on-demand polling access and a “push” model, which deals with standing queries. Depending on how the security for each individual EPCIS implementation is configured by, for example, an enterprise/organization that owns the particular EPCIS, rights may be granted for a user enterprise/organization of the EPCIS to define its own standing queries or the user enterprise/organization may only have the option of subscribing to an existing query, which, for example, has been pre-defined by the enterprise/organization provider of that particular EPCIS service. In many or most cases, one or more databases of EPC-related data is involved, though elements of the EPCIS could be used for direct application-to-application sharing without persistent databases.

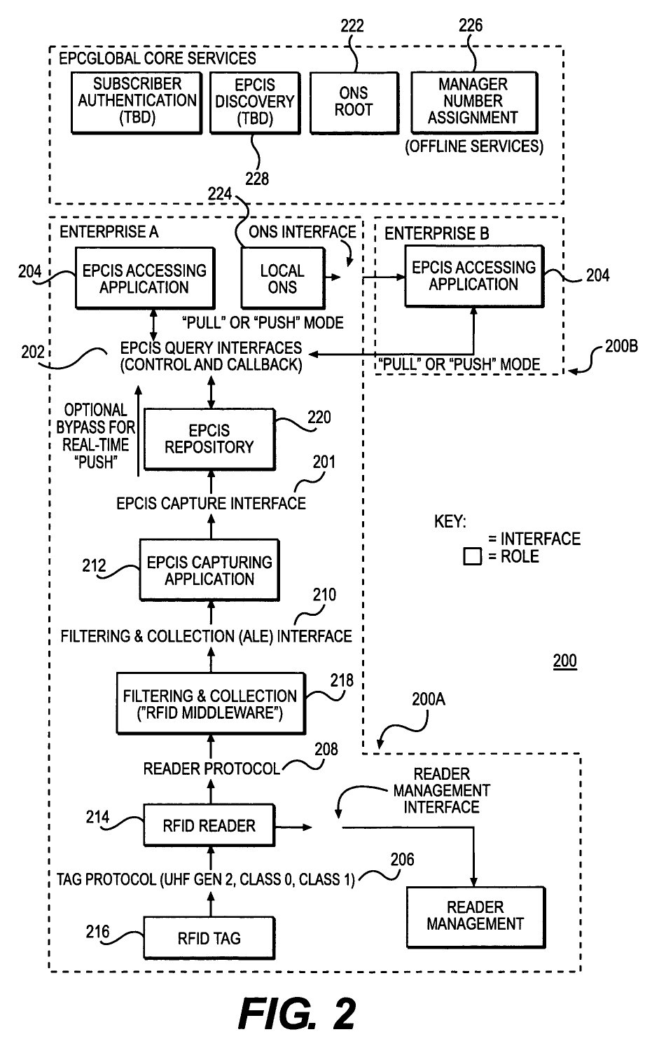

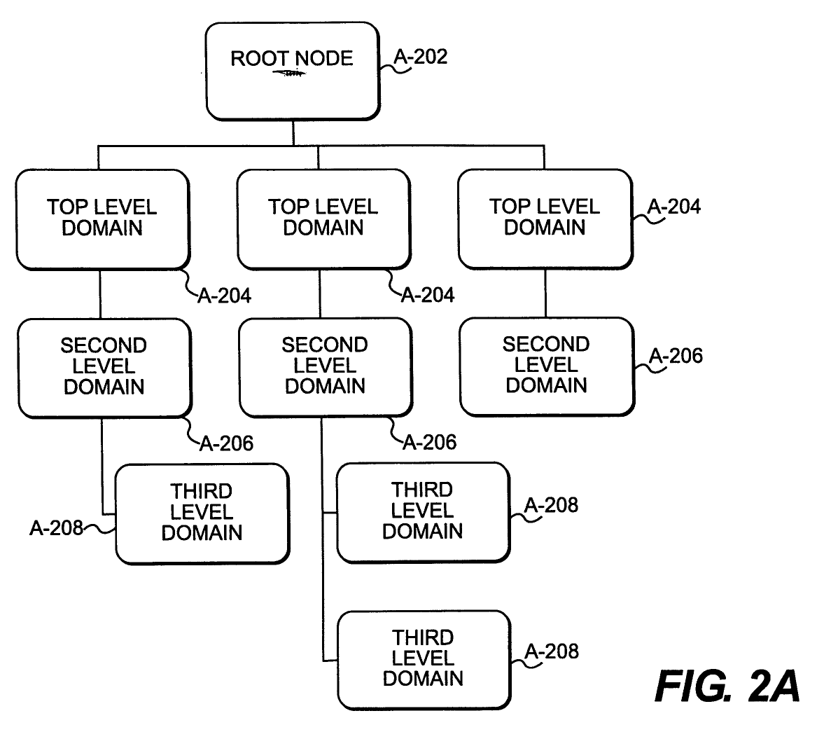

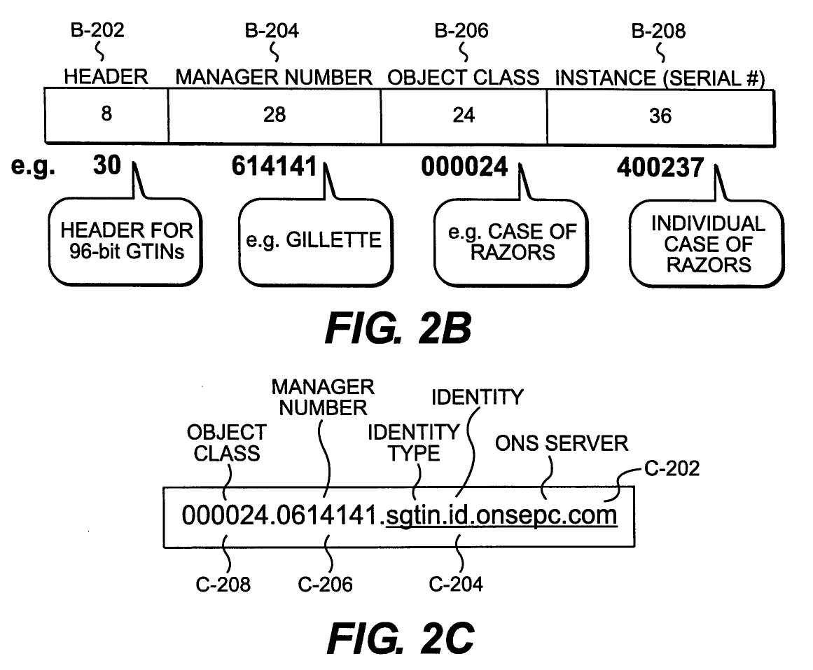

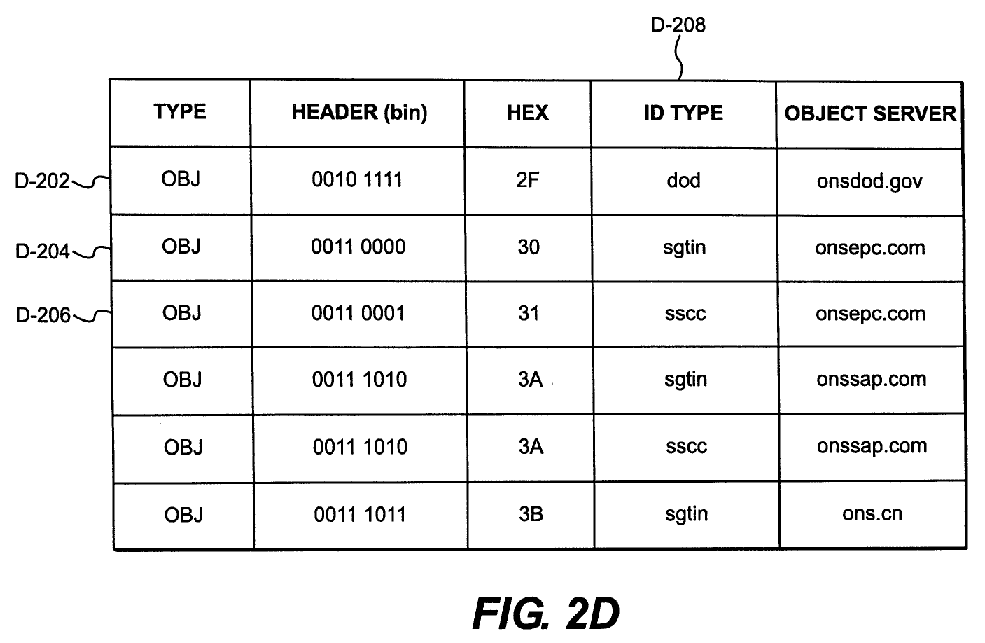

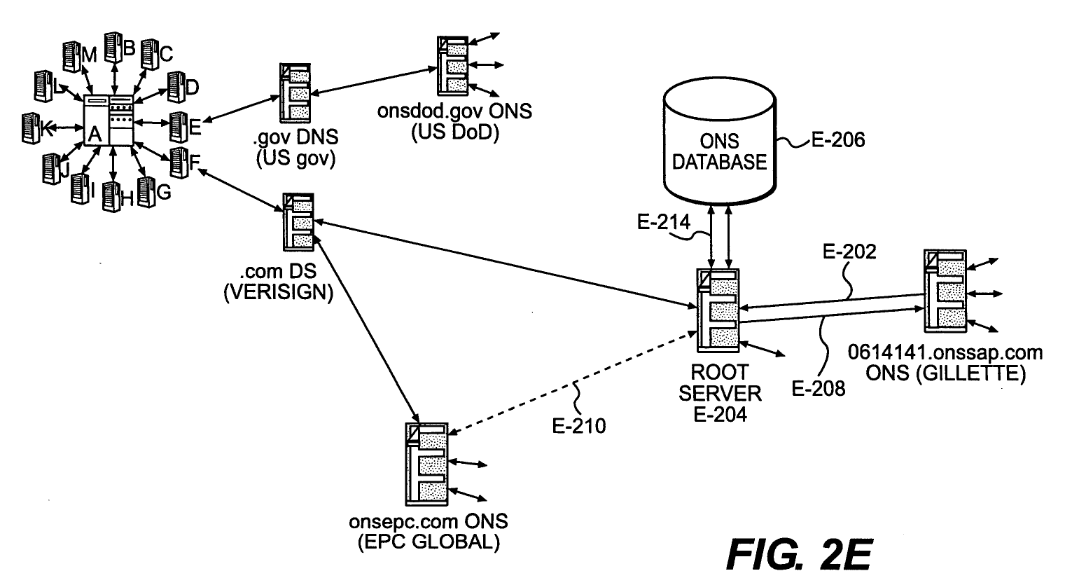

FIG. 2 is a schematic block diagram illustrating the relationships within an EPCglobal Architecture Framework 200. EPCglobal generally refers to an organization set up to achieve world-wide adoption and standardization of Electronic Product Code (EPC) technology. The main focus of the EPCglobal Architecture Framework 200 is to create both a world-wide standard for RFID and sharing of EPC-related data via the EPCglobal Network.

In FIG. 2, boxes denote roles played by hardware and/or software components of the system while the bars that have shadows denote interfaces governed by the various standards of EPCglobal, including the EPCIS. EPCglobal Architecture Framework 200 is divided between hardware and software components in Enterprise A, labeled 200A in FIG. 2, and Enterprise B (200B).

The flow of data from an RFID tag 216 in Enterprise A is depicted from the bottom to the top of 200A in FIG. 2. At the base bevel, RFID reader 214 makes one or more observations of RFID tag 216 when RFID tag 216 comes within the read zone of RFID reader 214, for example, when a product bearing RFID tag 216 passes through a warehouse door where RFID reader 214 is mounted. These raw EPC observations are governed by Tag Protocol 206. The raw tag observations made by RFID reader 214 are then delivered in accordance with the definition provided by Reader “Wireline” Protocol Interface 208 to Filtering & Collection 218, which is often referred to as the RFID middleware. The time interval for the collection of the raw tag observations by Filtering & Collection 218 may be determined by, for example, events defined by EPCIS Capturing Application 212. A suitable event may be, for example, the tripping of a motion detector on a product line.

The delivery of the filtered and collected tag read data from Filtering & Collection 218 to EPCIS Capturing Application 212 may be performed according to the control and definition specified by Filtering & Collection Interface 210. EPCIS Capturing Application 212 may supervise the operation of the lower-level architectural elements, for example, by providing filtering criteria to Filtering & Collection 218, and may provide business context by coordinating with other sources of information involved in executing a particular step of a business process. In essence, EPCIS Capturing Application 212 understands the business process steps during which data capture takes place and provides intelligent guidance with regard to what actions to take in connection with the data capture. For example, EPCIS Capturing Application 212, while coordinating a conveyor system with filtering and collection events, may check for exceptional conditions and take corrective action such as diverting a bad batch of products into a rework area.

Above EPCIS Capturing Application 212, at the top portion of EPCglobal Architecture Framework 200 resides the EPCIS Interfaces. These EPCIS Interfaces may include EPCIS Capture Interface 201 and EPCIS Query Interface. The EPCIS Interfaces provide EPC-related data to enterprise/organization-level roles such as EPCIS Repository 220 and EPCIS Accessing Application 204 both inside an enterprise/organization and outside of it, for example, at another enterprise/organization.

The EPCIS interfaces may include three specific interfaces: EPCIS Capture Interface 201, EPCIS Query Interfaces 202, and EPCIS Query Callback Interface, which is shown as a part of Interface 202 in FIG. 2. EPCIS Capture Interface 201 may define the delivery of EPCIS events from EPCIS Capturing Applications 212 to other roles that utilize the event data in real time, including EPCIS Repository 220. EPCIS Repository 220 may in turn store events generated by one or more EPCIS Capturing Applications, and may make these events available for later query, for example, by EPCIS Accessing Applications 204. EPCIS Capture Interface 201 may also “push” data in real time to EPCIS Accessing Applications 204.

EPCIS Query Control Interface 202, on the other hand, defines a means for EPCIS Accessing Application both inside and outside of the enterprise/organization to obtain EPCIS data subsequent to capture, for example, by first interacting with EPCIS Repository 220. Such interactions may take two forms. In the “on-demand” form, an EPCIS Accessing Application 204 may make a request through the EPCIS Query Control Interface 202 and receive a response based on EPC-related data immediately. In “standing request” or “asynchronous” mode, an EPCIS Accessing Application 204 may establish a subscription for a periodic query. Each time the periodic query is executed, the resulting EPC-related data may be delivered or “pushed” to the EPCIS Accessing Application asynchronously via EPCIS Query Callback Interface 202. EPCIS Query Callback Interface 202 may also be used to deliver information immediately upon capture, for example, in the form of a “real-time push.”

The fact that the EPCIS Interfaces are situated at the top portion of the EPCglobal Architecture Framework has several advantages. First, each of the interfaces in the lower framework levels insulates the higher levels of the framework from being weighed down by unnecessary details of how the lower levels are implemented. As an example, Reader Protocol Interface 208 insulates the higher levels from knowing what RF protocols are in use and/or what reader models are being used. Similarly, Filtering & Collection Interface insulates the higher levels from the design specifics with regard to how tags are sensed. For example, if a particular sensing arrangement is replaced with another, the events collected at Filtering & Collection level 218 should remain the same because of this insulation effect.

At the highest level, EPCIS insulates enterprise/organization applications such as EPCIS Accessing Applications 204 from having to understand the details in a business process. As an example, regardless of how an EPCIS event specifying that a particular situation occurred in a particular pallet was determined, whether by the observation and recordation of a human operator, by filtering of triggered events sent by a reader protocol interface to the Filtering and Collection level, or by any other method, the EPCIS event that is presented, for example, an EPCIS Accessing Application 204, remains unchanged.

The EPCIS Interfaces have a number of similarities to the interfaces at the lower levels of the EPCglobal Architecture Framework. However, the EPCIS Interfaces also differ from the elements at the lower levels of the EPCglobal Architecture Framework in a number of ways.

First, EPCIS works with historical EPC-related data as well as current EPC-related data. This is different from the lower levels of the framework, which are directed to the collection and processing of real-time EPC-related data.

Second, EPCIS works with business contexts and not just raw EPC-related observations. The business contexts provide a suitable lens through which the raw EPC-related observations may be analyzed, for example, to enable intelligent inferences to be made based on the observations within certain business applications. For example, an observation provided by Filtering & Collection 218 may indicate that a particular product bearing an EPC was seen at a particular reader at a particular time. This information while specific, has no business context. At the semantically higher level of the EPCIS, the above observation may be tied into a business context that provides the fact that the reader is located at a warehouse door, where the reader is triggered when new products arrive on a conveyor belt. Using this business context, the above observation may result in the inference that the product bearing the EPC is now stored in the warehouse and ready for shipping to retailers. In this way, the EPCIS incorporates into the event observation an understanding of the business context in which the EPC data were obtained so as to provide intelligent information that is useful in view of that business context. Because EPCIS allows storage of real-time EPC-related data, for example, in an EPCIS Repository 220, event information at the EPCIS level need not be directly tied to specific physical tag observations. For example, the EPCIS may provide inventory information that is generated based on inferences from history data stored within an EPCIS Repository 220.

Additionally, EPCIS is able to operate within a much more diverse network environment when compared to the elements at the lower levels of the EPCglobal Network Architecture Framework. EPCIS's adaptability to a multi-faceted network is particularly valuable when enterprises/organizations that have very different systems or network configurations wish to share data. In this regard, the insulation of EPCIS from the various lower levels within the framework, as discussed above, becomes particularly useful in shielding different implementations at the lower levels from accessing applications. In other words, EPCIS incorporates semantic information about business processes into raw EPC data and provides intelligent inferences based on raw and historical EPC data. In this way, EPCIS prevents and insulates applications that query and analyze information provided by EPCIS from understanding the detailed implementations and business processes within an enterprise/organization.

It should be noted that consistent with FIG. 2, EPCIS Accessing Applications 204 may reside either within the same network as the EPCIS Interfaces or within the systems of, for example, another enterprise/organization. In some embodiments, EPCIS Accessing Applications 204 residing within the systems of another enterprise/organization, such as Enterprise B (200B), may be granted access to a subset of the information that is available from an EPCIS Capturing Application 212 or within an EPCIS Repository 220. Details for granting access to a subset of the information via a enterprise/organization based access approach will be discussed in later sections.

In some embodiments, EPCglobal Architecture Framework 200 may have one or more associated complementary services. One of these complementary services may be an object name service (ONS) that is used to look-up pointers to one or more network accessible services, which are responsible for providing information and/or handling events associated with EPCs. This look-up service may enable an EPCIS accessing application to obtain desirable services that are, for example, implemented on distributed servers within the EPCglobal network without knowing exactly where these services are being provided.

In FIG. 2, ONS Root 222 and Local ONS 224 may provide such look-up services. For example, when supplied with an EPC, ONS Root 222 may identify pointers to one or more network accessible services that are responsible for providing services directed to the EPC. In some embodiments, unique identifiers other than EPCs may be used to identify pointers to services directed to items associated with these unique identifiers. As an example, an ISDN that singularly pinpoints a book may be used in connection with ONS Root 222 to look-up services directed to a book (e.g., online book dealers). Any other unique identifiers of products may be used in connection with ONS Root 222 to identify appropriate network accessible services direct to the items associated with such unique identifiers without departing from the spirit of the present invention.

Suitable network accessible services may include services hosted on a variety of systems as long as these services are capable of providing information and/or handling events associated with EPCs or other suitable identifiers. As an example, an EPCIS provided by a particular enterprise may constitute a network accessible service that handles events associated with one or more EPCs owned by the enterprise. As another example, a publisher's online book dealership may be a network accessible service that handles events associated with an ISDN assigned to one of its published books. Many other network accessible services may be provided to services products/items associated with various types of unique identifiers within the scope of the present invention.

Typically, an ONS does not contain actual data associated with the unique identifiers used to perform the look-up. Rather, the ONS is in possession of network addresses of services that may contain the detailed data associated with the unique identifiers and/or may execute processes directed to the unique identifiers. In some embodiments, the ONS may be implemented based on the existing Internet standards and infrastructure associated with Domain Name System (DNS). Specifically, queries for network accessible services may be formatted using the DNS standards. In particular, unique identifier used to query the ONS for services may be encoded in domain name form.

From the standpoint of a client application that uses the ONS to access network services, the ONS may appear completely non-transparent. For example, the client application may request service look-up through a simple application programming interface (API). In one suitable approach, the client application may simply supply a unique identifier, such as an EPC, through an API. In response, an ONS that is dedicated to performing service look-up for the client application may return a pointer, such as a network location, for the appropriate service associated with that unique identifier. During the whole look-up process, the client application may receive no information regarding how the look-up is being performed by the ONS. Using the pointer returned by the ONS, the client application may contact and directly communicate with the appropriate service, for example, a service hosted on a remotely located server to obtain desired information associated with the unique identifier.

From the perspective of a publisher for the ONS look-up service, the story is a bit more complicated. For example, if the ONS is provided based on the architecture and standards of DNS, a group of hierarchically-organized servers may be networked to roughly correspond to the hierarchy found in a domain name. One example of such a hierarchy is shown in FIG. 2A. At the top of this hierarchy may be root node A-202. In DNS, this level is generally referred to as “dot.” Root node A-202 may include entries for a plurality of top level domains. Some well-known DNS top level domains include “com,” “net,” “org,” etc. Each entry for a top level domain in node A-202 may indicate a corresponding Internet Protocol (IP) number for routing packets to a server that is responsible for managing that top level domain. Using these top level domain entries, root node A-202 may refer a request based on a particular domain name to one of the top level domains A-204.

Similar to the entries in root node A-202, each top level domain A-204 may also include entries indicating, for example, IP numbers for network servers that contain data for a subsection of the hierarchy within that top level domain. For example, in DNS, within the “.com” top level domain, there may be entries for second level domains A-206, which may include, for example an entry indicating IP numbers for “google.” This entry may point to a server that manages the subsection of the DNS hierarchy associated with “google.” This second level domain may additionally include entries of a plurality of third level domains A-208, which may include, for example, an entry indicating IP numbers for “mail” that points to a server for managing mail services within google. In this way, a distributed network database may be formed in which information is managed by distributed servers, where each server is globally accessible.

In an ONS based on the DNS architecture and standards, a unique identifier such as an EPC may be converted into domain name format, for example, by encoding the EPC as a Uniform Resource Identifier (URI) and incorporating the URI into a domain name. In one suitable application, the URI may include an EPC Manager Number such as one assigned by Manager Number Assignment 226 to uniquely identify a manager or owner of the EPC (e.g., an enterprise).

FIGS. 2B and 2C illustrate one suitable transition in which an EPC that is, for example, extracted from a 96-bit RFID tag is encoded in domain name format. Specifically, FIG. 2B shows an illustrative example of an EPC as encoded on a 96-bit RFID tag. As shown in this example, the 96 bits on the RFID tag may be divided into four portions, which may include header portion B-202, manager number portion B-204, object class portion B-206, and instance portion B-208. Header portion B-202 may store information that corresponds to a header assigned to a global trade item number. This header may be assigned, for example, by EPCglobal to reference different servers of EPCglobal that are dedicated to service certain subsets of the global trade items.

Manager number portion B-204 may include a manager number that, for example, uniquely identifies a provider of EPCIS such as an enterprise (e.g., Gillette). In some embodiments, the manager or EPCIS provider may own the EPCs for which it provides service. Object class portion B-206 may indicate a specific subset of data, for example, within the manager's service scope. In this particular example, the object class indicated relates to cases of razors within Gillette's service scope. Finally, instance portion B-208 may identify a specific instance of an item bearing the EPC, such as a particular case of razors.

FIG. 2C shows one suitable example of encoding an EPC such as the one shown in FIG. 2B into a domain name that may be used for ONS look-up within a hierarchy system similar to the one described above in connection with the DNS of FIG. 2A. In this example, onsepc.com portion C-202 encoded in DNS format may be automatically assign to all EPC-related domain names and may correspond to a top level domain A-204 of FIG. 2A. Portion C-202 may point to an ONS server that is, for example, assigned specifically by EPCglobal to provide ONS services.

In some embodiments, sgtin.id portion C-204 as shown in the exemplary domain name query may be derived from header portion B-202 of FIG. 2B and may correspond to various second level domains in the DNS scheme. Manager number portion C-206 of the domain name query may correspond to manager number B-204 shown in the RFID tag of FIG. 2B, and object class portion C-208 may correspond to object class B-206 in the RFID tag of FIG. 2B. Using this encoding method, every EPC extracted from an RFID tag, such as the one shown in FIG. 2B, may be translated into a domain name query as shown in FIG. 2C. The domain name query of FIG. 2C may then be used to map the EPC to network access services that are, for example, provided on distributed EPCIS servers, by an ONS implemented based on the DNS look-up scheme.

In some embodiments, more than one top level domains may be established to map headers of EPCs to different ONS root servers. Specifically, portion C-202 in the domain name query of FIG. 2C may vary based on variations in the header portion (e.g., B-202 of FIG. 2B) of an EPC. According to one suitable approach, a table or master directory may be established to map different header values to different ONS root servers. One example of such a table is shown in FIG. 2D. In this example, headers D-202 and D-204 are associated with different object servers. Using this map, an EPC having header D-202 may generate a domain name query ending in “onsdod.gov,” while an EPC having header D-204 may generate a domain name query ending in “onsepc.com.” Even when two headers map to the same object server as in the case of D-204 and D-206, the headers may map to different Id Types D-208 and be routed differently within that object server. The table of FIG. 2D thus allows EPCs to be mapped to a plurality of distributed root servers, where each root server may be managed, maintained, and/or owned by a plurality of enterprises/organizations.

In some embodiments, when multiple ONS root servers (e.g., those listed in the table of FIG. 2D) are used to provide look-up services, each ONS root server may locally cache data of other ONS servers. FIG. 2E illustrates one suitable scheme for implementing such local caching. At step E-202, an ONS root server E-204 may receive an ONS request, for example, from a client application. In response to the request, ONS root server E-204 may search its local ONS database E-206 for mapping information. If mapping information is found, root server E-204 may send an ONS reply back to the client application at step E-208. If, however, no mapping information is found on local ONS database E-206, root server E-204 may send out a remote ONS query at step E-210 to another ONS root server, such as for example, ONS server E-212 managed by EPCglobal or another server that “owns” the mapping information. When an ONS reply is received from the other ONS root server, the reply mapping information may be cached in local ONS database E-206 at step E-214 in addition to being forwarded to the client application. The cached ONS mapping information may enable any future client request for the same information to be provided locally without having to perform the remote ONS query of step E-210.

In some embodiments, each root server in a multiple root server ONS scheme may replicate data owned by other servers in addition to caching responses to remote ONS queries as discussed above. If each ONS root server fully replicate all data of other ONS servers in the network and the replication is performed regularly to keep the data current, each server may provide authoritative and accurate information to its querying client applications without having to perform any remote queries.

An alternative approach for providing ONS look-up services may involve the creation of a new top level domain within the existing DNS scheme. As an example, a separate “.obj” top level domain may be created in addition to the existing top level domains such as “.com,” “.net,” etc. Using this new domain, each ONS root server, for example, as indicated by a header associated with an EPC, may map to a different second level domain within the top level domain “.obj.” In some embodiments, every manager number associated with an EPC (e.g., representing an enterprise) may map to a different second level domain. This implementation may further simplify the ONS look-up process by cutting out the step of matching header information to find the relevant object servers associated with an EPC as discussed in connection with the table of FIG. 2B.

Regardless of variations in implementing the distributed ONS scheme, the essence of the scheme is that it allows a plurality of ONS servers, which may be owned, managed, and/or maintained by a plurality of entities, to look-up network access services that may provide data or execute processes in connection with EPCs or other unique identifiers supplied by client applications.

Referring back to FIG. 2, EPCIS Discovery 228 may be another complementary element to EPCglobal Architecture Framework 200. At a high level, EPCIS discovery 228 is capable of locating all EPCIS Repositories that may have data associated with a particular EPC. This discovery service is useful, for example, when an accessing application has no idea which EPCIS has EPC-related data that is relevant to a query that it wishes to perform. In one example, a retailer may wish to know the transport history of a product but has no idea which parties have participated in the transportation and storage of the product since the product left the manufacturer.

It should be noted that a single physical software or hardware component may play more than one role consistent with FIG. 2. For example, an enterprise/organization application such as a Warehouse Management System may simultaneously play the role of EPCIS Capturing Application 212, for example, to detect EPCs during product movement at loading time, and the role of EPCIS Accessing Application 204, for example, to analyze EPC-related data for making business decisions.

It should also be noted that FIG. 2 is merely an illustration of a suitable EPCglobal Architecture Framework. Appropriate additions, modifications, and deletions may be incorporated without departing from the spirit of the present invention.

It is apparent from the above description of the general EPCglobal Architecture Framework that EPCIS, which provides a more comprehensive insulation of technical implementations and business processes at the lower level, needs a complementary richer set of access techniques. For example, the incorporation of business context will require that the EPCIS be capable of handling a variety of data types and be flexible enough so that it may be expanded or extended to accommodate new and different business contexts. Also, in anticipation of widely different systems and networks that the EPCIS must adapt to across enterprises/organizations, the EPCIS must be structured carefully so as to maintain consistency and interoperability.

With these requirements in mind, the EPCIS may be implemented in accordance with a framework that is layered, extensible, and modular. With regard to being layered, the structure of data in connection with EPCIS may be defined separately from the particulars of data access services and interface protocols. This separation enables the EPCIS data to maintain consistent meaning across the enterprises/organizations over time regardless of changes that might be made to the data access services or the interface protocols. This may also enable the separately defined EPCIS data to be used in other frameworks, such as an EDI framework.

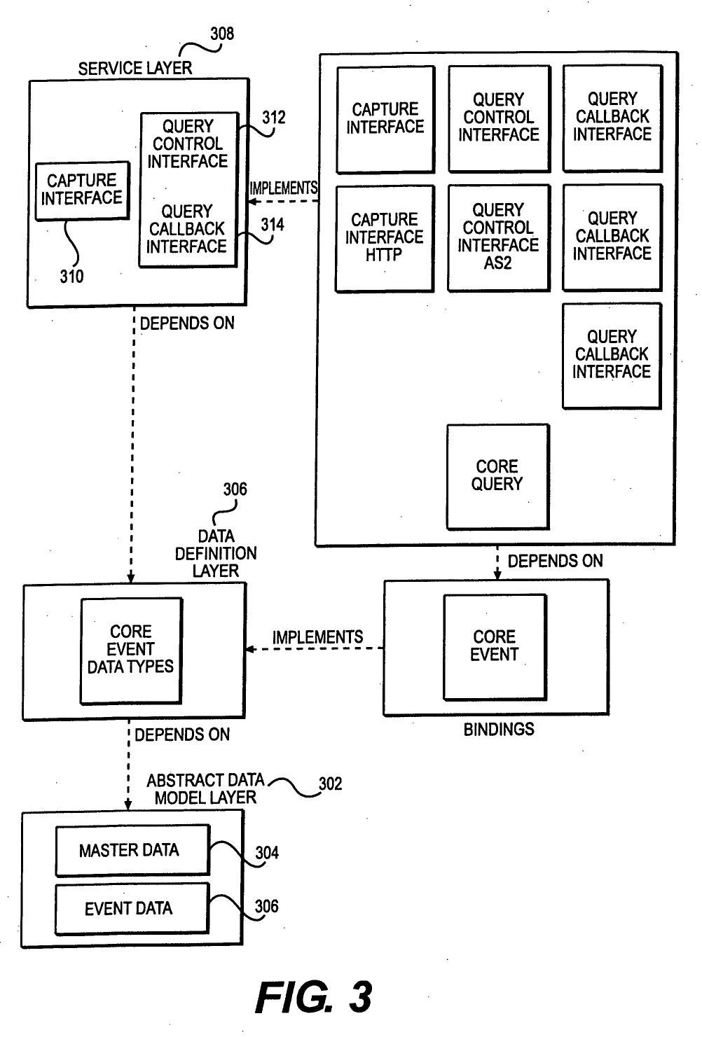

FIG. 3 shows a block diagram of suitable layers that may be implemented in connection with an EPCIS framework. At the bottom level of this framework lies Abstract Data Model Layer 302. This layer may define the generic structure of EPCIS data and may be made non-extensible without revising the EPCIS core specification. By not allowing extension to be added freely, Abstract Data Model Layer 302 maintains a consistent set of general requirements for creating data definition.

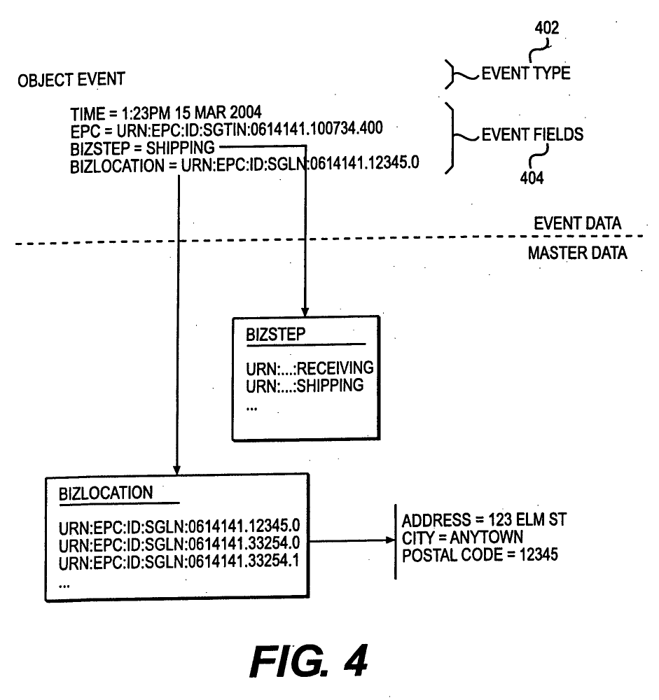

Generally, Abstract Data Model Layer 302 may include two types of data: master data 304 and event data 306. Event data 306 may be any suitable data that is generated during the business processes and captured, for example, by an EPCIS Capturing Interface, such as interface 201 of FIG. 2. An example of event data may be a specific observation of an EPC at a particular time by a particular reader. Event data 306 may be made available for querying, for example, through an EPCIS Query Interface, such as interface 202 of FIG. 2. An illustrative set of event data is shown in the top portion of FIG. 4. In this example, the event data describes a specific EPC that has been observed at a specific bizLocation at a specific time during a shipping step.

Master data 304 does not deal with actual observations of events, but is additional data that defines a business context for interpreting the event data. As an example, master data 304 may include identifiers for locations, business process steps, and other business context that can provide business meaning to the raw observations contained in event data 306. An illustrative set of master data is shown in the bottom portion of FIG. 4. In this example, the master data lays out all the possible bizSteps from which the shipping step was chosen and all the possible BizLocations from which the actual BizLocation in the event data was chosen, and how those BizLocations may correspond to actual locations.

Referring back to FIG. 3, Data Definition Layer 306 may be found above Abstract Data Model Layer 302. Data Definition Layer 306 may define at a higher level what data is allowed to be exchanged through EPCIS, what type of abstract structure this data should take on, and what the data means. Data definitions made in Data Definition Layer 306 conform to the set of rules specified in Abstract Data Model Layer 302 below. As an example, event types, as illustrated by event type 402 in FIG. 4, may be defined in Data Definition Layer 306 and may specify a list of standard event fields 404 for each event type. An event type may also include other subclass event types. The event types 402 defined may be consistent with the rules associated with raw event data 306 specified in Abstract Data Model Layer 302.

Service Layer 308 may be found above Data Definition Layer 306 in FIG. 3. This layer defines the service interfaces that clients of EPCIS interact with. According to one suitable approach, the interface definitions in the service layer may be specified abstractly using UML. Some illustrative interfaces that may be defined in this layer may include, for example, EPCIS Capture Interface 310, EPCIS Query Control Interface 312, and EPCIS Callback Interface 314.

In addition to being layered, the core specifications of the EPCIS, which may include, for example, various data types and operations that are applicable across enterprises/organizations, may be made extensible to include other data types, operations, etc. that are particular to a particular enterprise/organization or industry. This ability to make additions to the core specifications strengthens the concept of a more standardized core, because it allows particularities that do not conform to the standard core to be included as extensions. The layering and extensibility mechanisms allow different parts of the EPCIS to be specified by different documents and at the same time promote coherence across the entire framework to ensuring standardization.

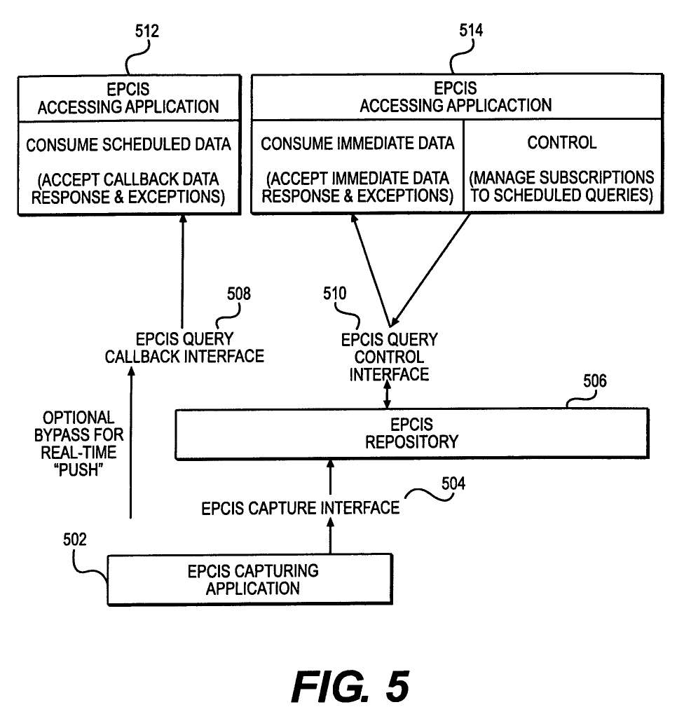

On a more specific level, FIG. 5 provides a block diagram of one suitable arrangement for allowing the EPCIS interfaces to interact with each other and with EPCIS accessing applications. At the lower level, EPCIS Capture Application 502 may deliver core events to EPCIS Capture Interface 504. Means may be provided for EPCIS Capture Application 502 and EPCIS Capture Interface 504 to mutually authenticate each other. A capture operation may be permitted or prevented based on the success of the mutual authentication. As an example, “message bus” technology may be used by EPCIS Capture Interface 504 to interconnect different distributed system components and provide a channel for in-order delivery of messages by designating a particular message bus channel, for example, to deliver EPCIS events from an EPCIS Capture Application 502 to EPCIS Repository 506.

EPCIS Query Callback Interface 508 and EPCIS Query Control Interface 510 may enable EPCIS data to be retrieved by EPCIS Accessing Applications 512 and 514. In particular, EPCIS Query Control Interface 510 allows EPCIS Accessing Application to retrieve data on-demand and to enter subscriptions for standing queries, which may be any suitable queries that are pre-determined and run, for example, periodically or in response to certain triggering event, to generate EPCIS data. Result of such standing queries may be delivered to EPCIS Accessing Application 512 via EPCIS Query Callback Interface 508. Similar to the authentication performed at the EPCIS Capture Interface level, means may be provided, for example, for a requesting EPCIS Accessing Application 512 or 514 to be authenticated through EPCIS Query Control Interface 510 or EPCIS Query Callback Interface 508. Once authenticated, EPCIS Accessing Application 514 may gain access to EPCIS data through an EPCIS interface based on the appropriate authorization associated with EPCIS Accessing Application 514.

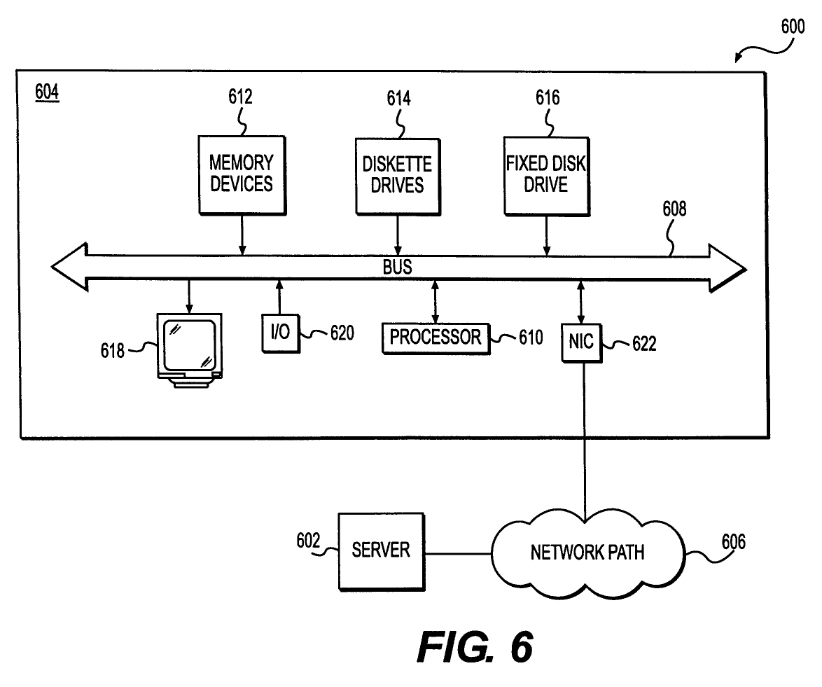

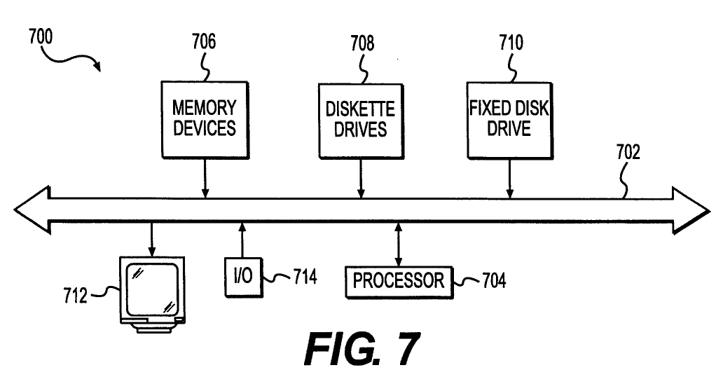

A computer system may be used to install a software application implementing a system and method for providing EPCIS interfaces capable of allowing one or more EPCIS accessing applications residing on a variety of systems and associated with a plurality of enterprises/organizations to receive EPC-related data. The computer system may be a computer network, as shown in FIG. 6, or a stand-alone personal computer (PC), as shown in FIG. 7.

As shown in FIG. 6, a computer network 600 in accordance with systems consistent with the principles of the present invention may include a server 602 and a stand-alone PC 604 connected through a network path 606. Computer network 600 may be a local area network (LAN), where server 602 and PC 604 are workstations. Computer network 600 may also be the Internet, with server 602 hosting a web application and PC 604 being any workstation available to a user desiring to interface with the application on server 602. Alternatively, computer network 600 may be a wide area network (WAN), and server 602 and PC 604 may lie in two separate LANs connected through the Internet.

PC 604 may include a bus line 608 connecting a plurality of devices such as a processor 610, memory devices 612 for storage of information, diskette drives 614, a fixed disk drive 616, a monitor or display 618, other I/O devices 620, and a network interface card (NIC) 622. Processor 610 may be a microprocessor such as an Intel Pentium™ chip for processing applications. Memory devices 612 may include read-only memories (ROM) and/or random access memories (RAM). Diskette drives 614 may include a floppy drive and/or a compact disk (CD) drive. Fixed disk drive 616 may be a hard drive. I/O devices 620 may include a keyboard and/or a mouse for receiving input from a user of PC 604. Monitor or display 618 may display output from processor 610, and may also echo the input of the user. PC 604 may be connected to network path 606 through NIC 622.

A web application may be installed on server 602. An individual desiring to enter data into the application on server 602 may use a web browser loaded on PC 604, and may communicate with server 602 through NIC 622 and network path 606. In one aspect, software application for implementing a system consistent with the principles of the present invention may be stored in PC 604 and processor 610 of PC 604 may execute the software application locally within PC 604 and interface with a web application on server 602. Particularly, the software application may be stored on a floppy disk, a CD, or any other suitable readable media, which may be accessible by diskette drive 614, fixed disk drive 616, or any other suitable mechanism. In another aspect, the software application for implementing a system consistent with the principles of the present invention may be stored in server 602, which may execute the software application, and processor 610 of PC 604 may communicate with server 602 to send information to server 602 and retrieve the results of the execution of the software application from server 602.

Through the execution of the software application implementing a system consistent with the principles of the present invention, either locally within PC 604 or remotely within server 602, an interface or screen may be provided on a user display.

Alternatively, as shown in FIG. 7, a stand-alone PC 700 may be used for implementing a software application implementing a system consistent with the principles of the present invention. PC 700 may include a bus line 702 connecting a plurality of devices, which may include a processor 704, memory devices 706 for storage of information, diskette drives 708, a fixed disk drive 710, a monitor or display 712, and other I/O devices 714. Processor 704 may be a microprocessor such as an Intel Pentium™ chip for processing applications. Memory devices 706 may include ROM and/or RAM. Diskette drives 708 may include a floppy drive and/or a compact disk (CD) drive. Fixed disk drive 710 may be a hard drive. Monitor or display 712 may display the output of processor 704 and may also echo the input of the user. I/O devices 714 may include a keyboard and/or a mouse for receiving input from a user of PC 700.

A software application implementing a system consistent with the principles of the present invention may be stored on a floppy disk or a CD accessible by diskette drive 708 or on fixed disk drive 710. Processor 704 may execute the software application stored in the floppy disk the CD or the fixed disk drive 710. An individual, through monitor or display 712 and I/O devices 714, may interact with processor 704, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for providing an Object Name Service (ONS) through a plurality of distributed ONS root servers that are managed by different entities, comprising:
providing an interface capable of allowing one or more accessing applications residing on a variety of systems and associated with a plurality of enterprises/organizations to receive sensor-related data;
receiving from an accessing application a unique code at one of the ONS root servers, wherein the ONS root server uses at least a portion of the unique code to identify a network accessible service that provides data associated with the unique code; and
responding to the accessing application with a pointer to the network accessible service to allow the accessing application to receive data associated with the unique code from the network accessible service.

2. The method of claim 1, wherein the ONS root server identifies the network accessible service using a look-up system based on Domain Name System.

3. The method of claim 1, wherein the ONS root server has access to a directory that matches headers of unique codes with object servers that manage network accessing services directed to those unique codes and the ONS root server uses a header associated with the received unique code to identify, from the directory, a server that has information on the network accessing service that provides data associated with the received unique code.

4. The method of claim 1, wherein the ONS root server uses a manager number associated with the unique code to identify a server dedicated to providing data associated with unique codes having that manager number.

5. The method of claim 1, wherein the ONS root server that received the unique code queries another of the plurality of ONS root server to identify the network accessible service that provides data associated with the unique code and locally caches the pointer to the identified network accessible service.

6. The method of claim 1, wherein the ONS root server replicates data associated with the other of the plurality of ONS servers.
